(19) United States
(12) Patent Application Publication
(10) Pub. No.: US 2006/0184078 A1
(43) Pub. Date: Aug. 17, 2006

(54) Apparatus for scratching beneath a covering

(76) Inventors: Matthew A. Robertson, St. Louis, MO (US); James E. Ahern, St. Peters, MO (US)

Correspondence Address: Charles Livingston, 1804 Hickory St., St. Louis, MO, 63104, US

(21) Appl. No.: 11/057,727

(22) Filed: Feb. 14, 2005

(51) Int. Cl. A61H 7/00

(52) U.S. Cl. 601/137

(57) ABSTRACT

Apparatus for scratching beneath a covering. The apparatus includes an elongate body sized to be at least partially received between the covering and skin covered by the covering, and a protrusion extending outward from the body for scratching an outer surface of the covered skin. A cross section of the body is generally non-quadrilateral with at least one generally linear side. The cross section does not extend through the protrusion.

### BACKGROUND OF THE INVENTION

The present invention relates generally to coverings such as casts, splints, bandages, clothes, shoes, etc., and more specifically to apparatus for scratching beneath coverings.

Coverings such as casts, splints, and bandages are often used to immobilize and/or protect a portion of a person's body, such as an arm, leg, etc. Similarly, clothing, including shoes and hats, may be used as coverings to conceal, protect, and/or provide warmth to a person's body. The tight enclosure of the covering can often cause discomfort, such as itchiness and/or other uncomfortable sensations. For example, portions of the covering may rub against covered skin and/or the covered skin may sweat abnormally. Debris such as dead skin dislodged by the covering and/or pieces broken from the covering may also cause discomfort. With some coverings such as casts, splints, bandages, etc., people are often advised against relieving the discomfort to prevent damage to the covering and injury to the covered skin. Although clothing may be manipulated and/or partially or completely removed to reach the area of discomfort, it may be inconvenient and/or inappropriate, particularly in a crowded environment such as a business meeting or public area. People may indeed attempt to just “live with it”, however, a nagging itch may cause even the most disciplined to attempt relief. Consequently, a frustrated person may be compelled to attempt inconvenient, and possibly embarrassingly inappropriate relief by manipulating and/or removing the covering. Additionally, the person may damage the covering and/or injure the skin, for example by sticking a sharp object between the covering and skin.

### SUMMARY OF THE INVENTION

In one aspect, apparatus is provided for scratching beneath a covering. The apparatus includes an elongate body sized to be at least partially received between the covering and skin covered by the covering, and a protrusion extending outward from the body for scratching an outer surface of the covered skin. A cross section of the body is generally non-quadrilateral with at least one generally linear side. The cross section does not extend through the protrusion.

In another aspect, apparatus is provided for scratching beneath a covering. The apparatus includes an elongate body sized to be at least partially received between the covering and skin covered by the covering. The body has a longitudinal axis extending through a length thereof. A cross section of the body is generally symmetrical about a first axis extending through the body and is generally non-symmetrical about a second axis extending through the body. The first axis is generally perpendicular to the second axis and both the first and second axes are generally perpendicular to the longitudinal axis of the body. The cross section is taken along a line generally perpendicular to the longitudinal axis of the body. The apparatus also includes a protrusion extending outward from the body for scratching an outer surface of the skin covered by the covering. The cross section of the body does not extend through the protrusion.

In yet another aspect, apparatus is provided for scratching beneath a covering. The apparatus includes an elongate body sized to be at least partially received between the covering and skin covered by the covering, and a protrusion extending outward from the body for scratching an outer surface of the covered skin. The protrusion extends outward from the body along a length one of substantially equal to and greater than a width of the body.

In another aspect, apparatus is provided for scratching beneath a covering. The apparatus includes an elongate body sized to be at least partially received between the covering and skin covered by the covering. The apparatus also includes a protrusion extending outward from the body for scratching an outer surface of the skin covered by the covering, wherein a cross section of the body and the protrusion includes a generally linear side. The protrusion extends outward from the body along a length one of substantially equal to and greater than a length of the linear side.

In another aspect, apparatus is provided for scratching beneath a covering. The apparatus includes an elongate body sized to be at least partially received between the covering and skin covered by the covering, and a protrusion extending outward from the body for scratching an outer surface of the covered skin. The protrusion includes a front side extending from the body to an outer edge of the protrusion and a back side extending from the body to the outer edge.

In even another aspect, apparatus is provided for scratching beneath a covering. The apparatus includes an elongate body sized to be at least partially received between the covering and skin covered by the covering, and a protrusion extending outward from the body for scratching an outer surface of the covered skin. A cross section of the body and the protrusion is at least one of generally triangular, generally quadrilateral, and comprised of no more than five sides.

In another aspect, apparatus is provided for scratching beneath a covering. The apparatus includes an elongate body sized to be at least partially received between the covering and skin covered by the covering, and a protrusion extending outward from the body for scratching an outer surface of the covered skin. A cross section of the body and the protrusion includes a generally linear side and a generally curved side. The generally curved side extends from a first end of the generally linear side to a second end of the generally linear side opposite the first end.

In even another aspect, apparatus is provided for scratching beneath a covering. The apparatus includes an elongate body sized to be at least partially received between the covering and skin covered by the covering, and a plurality of protrusions extending outward from the body for scratching an outer surface of the covered skin. The plurality of protrusions are arranged sequentially along a longitudinal axis extending through a length of the body.

Other features of the present invention will be in part apparent and in part pointed out hereinafter.

### BRIEF DESCRIPTION OF THE DRAWINGS

FIG. 1 is a partially cut-away perspective illustrating one embodiment of apparatus of the present invention for scratching beneath a covering wherein the apparatus is partially received beneath a covering;

FIG. 2 is a top plan of the apparatus shown in FIG. 1;

FIG. 3 is a side elevation of the apparatus shown in FIG. 1;

FIG. 4 is a cross section of the apparatus taken along line 4-4 of FIG. 2;

FIGS. 5-10 are a cross sections of various alternative embodiments of the apparatus of the present invention;

FIG. 11 is a detail of FIG. 3 taken about detail 11 of FIG. 3;

FIG. 12 is a cross section of the apparatus taken along line 12-12 of FIG. 2;

FIG. 13 is a detail of FIG. 12 taken about detail 13 of FIG. 12;

FIGS. 14-17 are cross sections of various alternative embodiments of the apparatus of the present invention;

FIG. 18 is a cross section of the apparatus taken along line 18-18 of FIG. 2; and

FIGS. 19-22 are cross sections of various alternative embodiments of the apparatus of the present invention.

Corresponding reference characters indicate corresponding parts throughout the several views of the drawings.

### DETAILED DESCRIPTION OF THE PREFERRED EMBODIMENT

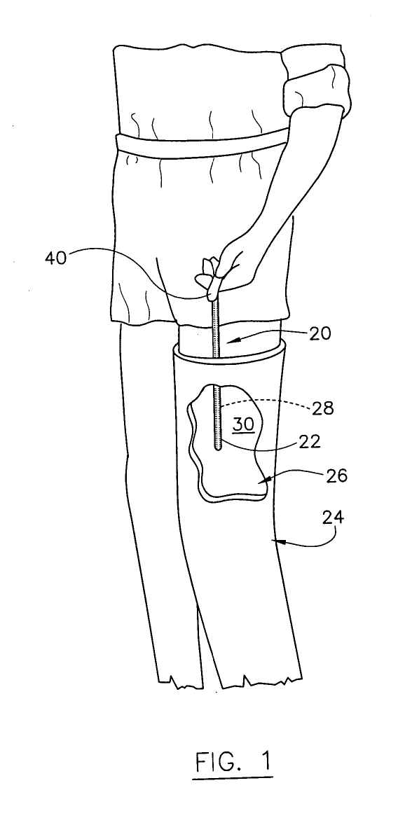

Referring now to the drawings, and more specifically to FIG. 1, apparatus of the present invention for scratching beneath a covering is designated in its entirety by the reference numeral 20. The apparatus 20 includes an elongate body 22 sized to be at least partially received between a covering (e.g., the cast generally designated by 24) and skin (e.g., the skin generally designated by 26) covered by the cast. A protrusion 28 extends outward from the body for scratching an outer surface 30 of the skin 26. In use, at least a portion of the body 22 is received between the cast 24 and the skin 26 and is moved along the skin beneath the cast. As the body 22 is moved along the outer surface 30 of the skin 26, the protrusion(s) 28 scratch the outer surface to relieve discomfort such as itchiness and/or other uncomfortable sensations.

Although the body 22 is generally shown and described herein as having a plurality of protrusions 28 extending outward therefrom, the body may include any number of protrusions extending therefrom, including only one, without departing from the scope of the present invention.

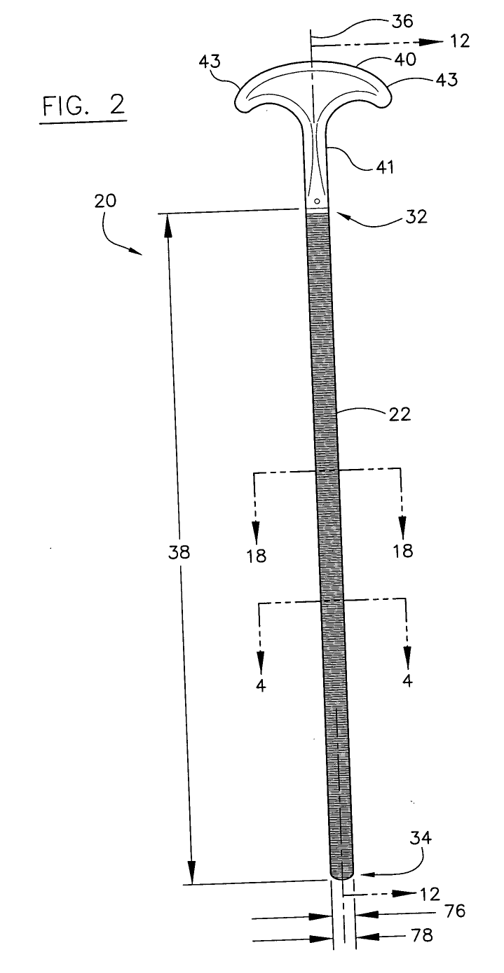

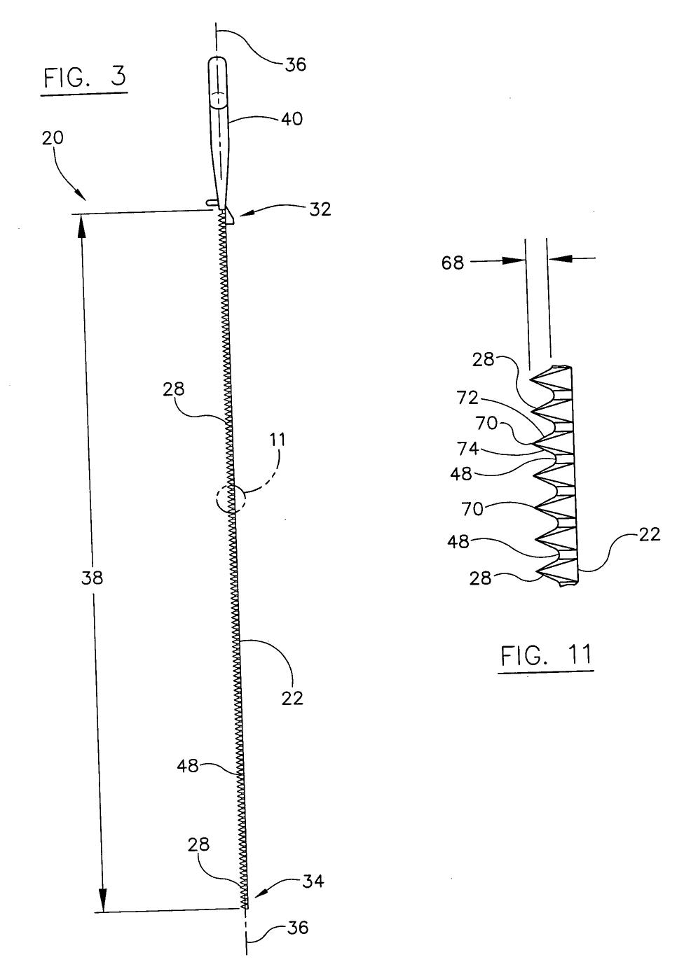

As shown in FIGS. 2 and 3, the body 22 extends between a first end (generally designated by 32) and a second end (generally designated by 34) opposite the first end. A longitudinal axis 36 extends through a length of the body from the first end 32 to the second end 34. As discussed above, the body is sized to be at least partially received between the cast 24 (FIG. 1) and the skin 26 (FIG. 1) covered by the cast. Although the body 22 may have other lengths without departing from the scope of the present invention, in one embodiment the body has a length 38 measured between the first end 32 and the second end 34 of between about 1 inches and about 60 inches. The specific length of the body 22 as measured between the first end 32 and the second end 34 may, in one embodiment, be sized to be received between a predetermined sized and/or shaped cast. In one embodiment, the body 22 includes a handle 40 to facilitate moving the body 22 along the skin 26 beneath the cast 24 and to facilitate generally holding the apparatus 20. Although the handle may be positioned on any portion of the body 22 without departing from the scope of the present invention, as shown herein the handle extends from the first end 32. Although the handle may have any size and/or shape without departing from the scope of the present invention, as shown in FIG. 2 in one embodiment the handle 40 includes a central stem 41 extending from the first end 32 and two extensions 43 extending outwardly from the stem. The extensions 43 facilitate grasping of the apparatus 20 by a person's fingers or toes. In one embodiment, the extensions are curved as shown in FIG. 2 to facilitate interconnection between the fingers and/or toes and the extensions. Although the handle 40 is shown herein having two extensions 43, the handle may include any number of extensions, including only one, without departing from the scope of the present invention.

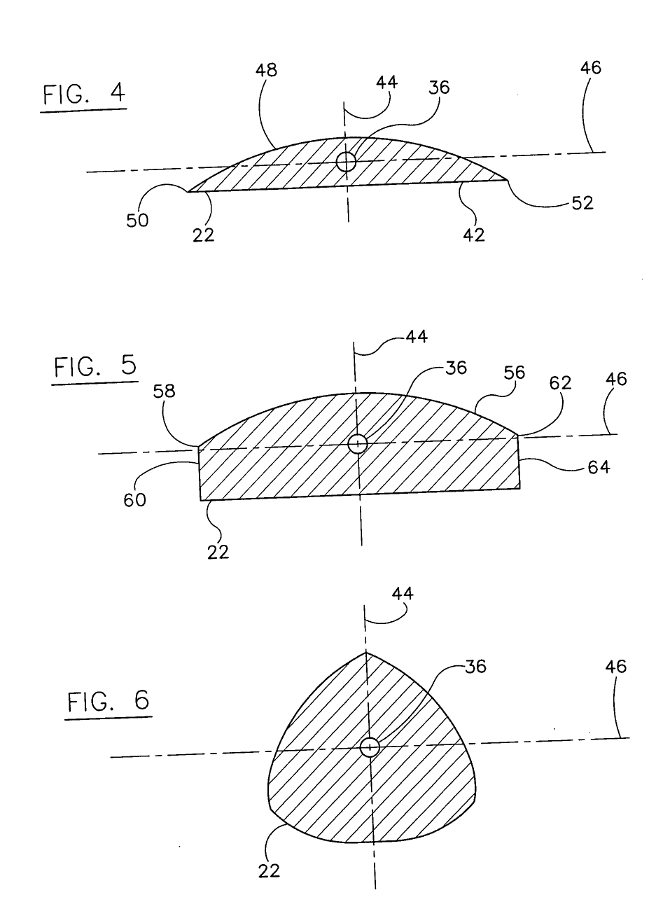

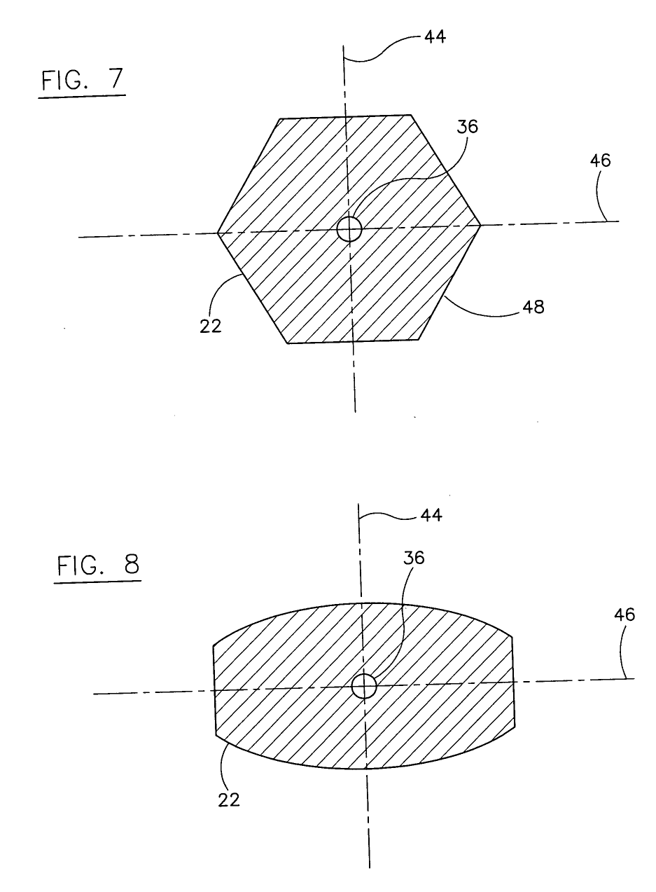

Although the body may include any suitable cross-sectional shape without departing from the scope of the present invention, as illustrated in FIG. 4 in one embodiment the body 22 includes a cross-sectional shape that is generally non-quadrilateral with at least one generally linear side 42. Also illustrated in FIG. 4 is an embodiment wherein the body 22 includes a cross-sectional shape that is generally symmetrical about an axis 44 extending through the body 22 but generally non-symmetrical about another axis 46 extending through the body that is generally perpendicular to the axis 44. Either of the axis 44 and/or the axis 46 may be referred to herein as a first or a second axis. Although the apparatus 20 shown in FIG. 4 includes both a cross-sectional shape that is generally non-quadrilateral with at least one generally linear side and a cross-sectional shape that is generally symmetrical about the axis 44 but not the axis 46, in other embodiments a portion(s) or all of the body may have one or any number of such features without departing from the scope of the present invention. For example, as shown in FIG. 5 in one embodiment the body 22 includes a cross-sectional shape that is generally symmetrical about the axis 44 and generally non-symmetrical about the axis 46, but is generally quadrilateral. FIG. 6 illustrates one embodiment wherein the body includes a cross-sectional shape that is generally symmetrical about the axis 44 and generally non-symmetrical about the axis 46, and generally non-quadrilateral, however does not include a generally linear side. FIG. 7 illustrates one embodiment wherein the body 22 includes a cross-sectional shape that is generally non-quadrilateral with at least one generally linear side 48, but is generally symmetrical about both the axes 44 and 46. FIG. 8 illustrates an example where the body 22 includes a cross-sectional shape that is generally quadrilateral and is generally symmetrical about both the axes 44 and 46.

The cross section of the body 22 of the embodiment shown in FIG. 4 includes the generally linear side 42 and a generally curved side 48. The curved side 48 has a generally constant radius and extends from a first end 50 of the generally linear side 42 to a second end 52 of the generally linear side opposite the first end, such that the cross section of FIG. 5 is generally semicircular. However, in other embodiments the cross sectional shapes of the body 22 described and/or illustrated herein may include a curved side with a variable radius without departing from the scope of the present invention (e.g., the curved side 54 of FIG. 9). Additionally, in other embodiments the cross sectional shapes of the body 22 described and/or illustrated herein may include a curved side that does not extend all way from one end of a linear side to another end of the same linear side. For example, FIG. 5 illustrates a curved side 56 that extends from an end 58 of a linear side 60 to an end 62 of another linear side 64. Although the cross section of the body 22 shown in FIG. 4 includes only two sides, a cross section of the body 22 may have any number of sides without departing from the scope of the present invention.

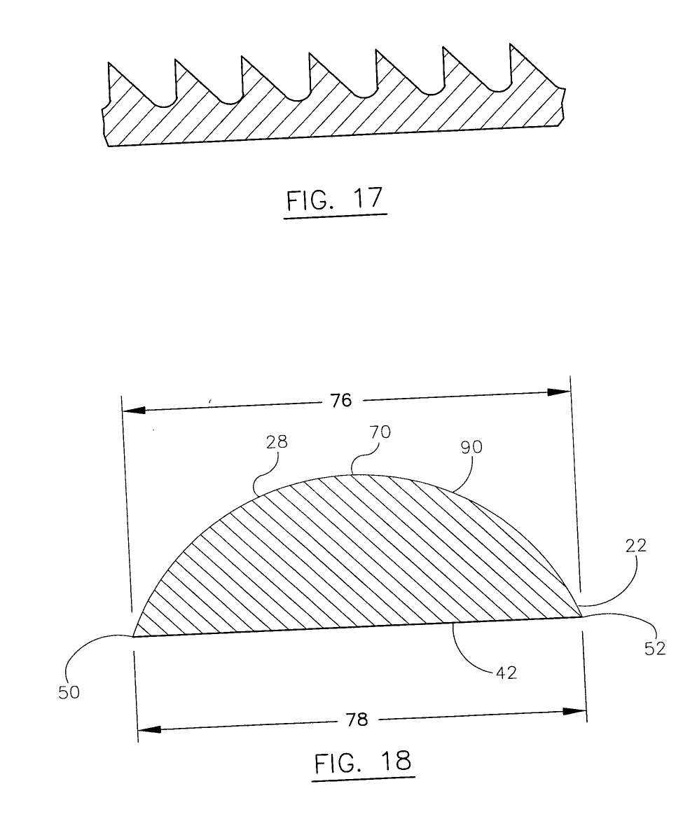

Other cross sectional shapes for all or a portion(s) of the body 22 (in place of and/or in addition to other cross-sectional shapes described and/or illustrated herein) besides a two-sided cross-sectional shape as shown in FIGS. 4 and 9, include, but are not limited to, generally triangular (e.g., the cross section of FIG. 10 including rounded edges 66; the cross sections of FIGS. 6 and 14), generally quadrilateral (e.g., the cross sections of FIGS. 5 and 8), and/or comprised of at least five sides (e.g., FIG. 7).

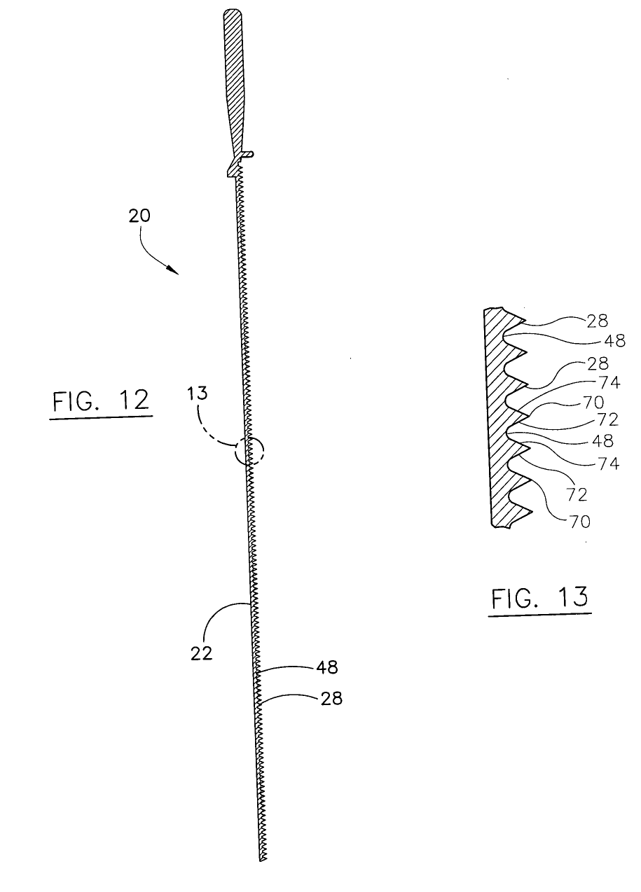

Of course, if any or generally all of the body 22 includes a cross-sectional shape as shown in FIGS. 5-10, the appearance of the apparatus 20, and specifically the body 22, may appear different than the embodiment as shown in FIGS. 1-4, 11, 12, 13, and 18.

As can be seen from FIG. 2, the cross section of FIG. 4 (and/or in one embodiment the cross sections of FIGS. 5-10) is taken along a line generally perpendicular to the longitudinal axis 36 of the body 22. However, in other embodiments the cross sectional shapes of the body 22 described and/or illustrated herein may be taken along lines generally not perpendicular to the longitudinal axis 36 of the body without departing from the scope of the present invention. Additionally, as shown in FIG. 4 (and/or in one embodiment, as shown in FIGS. 5-10) both the axes 44, 46 are perpendicular to the longitudinal axis 36 of the body and are aligned with the cross section of FIG. 4 (and/or in one embodiment the axes 44, 46 are aligned with the cross section of FIG. 5-10). However, in other embodiments the cross sectional shapes of the body 22 described and/or illustrated herein may be symmetrical and/or non-symmetrical about lines generally not perpendicular to the longitudinal axis 36 (and whether or not aligned with the cross section) without departing from the scope of the present invention. Furthermore, as can be seen from FIG. 2, the cross section of FIG. 4 (and/or in one embodiment the cross sections of FIG. 5-10) does not extend through a protrusion 28. However, in other embodiments the cross sectional shapes of the body 22 described and/or illustrated herein may extend through a protrusion 28 without departing from the scope of the present invention.

As used herein, the curved side 48 represents both the two-dimensional side 48 of the two-dimensional cross section of FIG. 4, and the three-dimensional side 48 that the protrusions 28 extend from, shown in the three-dimensional FIG. 1 as well as the two dimensional FIGS. 2, 3, and 11-13. Portions of the curved side 48 that the protrusions 28 extend from are of course obscured in FIGS. 1-3 and 11-13 by the protrusions themselves.

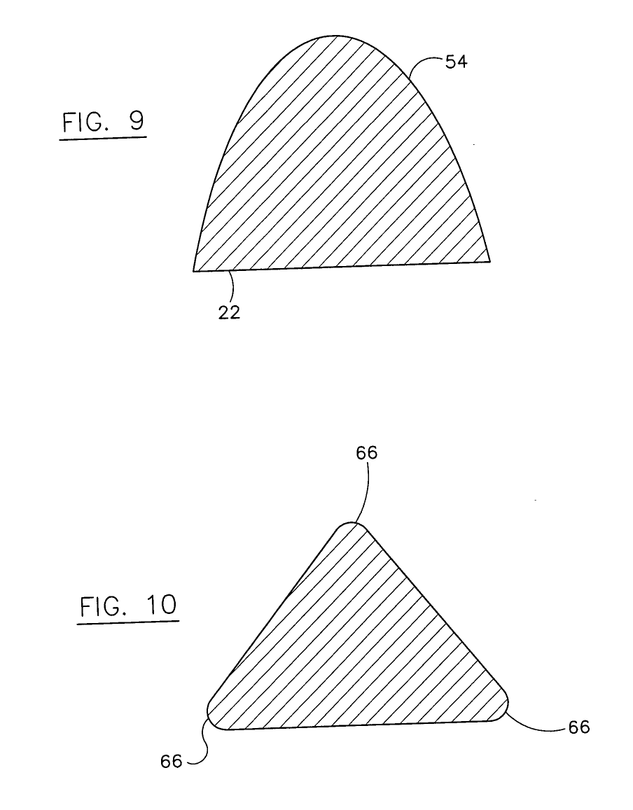

As shown in FIGS. 3 and 11-13, in the embodiment of FIGS. 1-4, 11, 12, 13, and 18 each of the protrusions 28 extends outward from the curved side 48 of the body 22. However, any of the protrusions 28 may extend outwardly from any portion of the body 22 without departing from the scope of the present invention. For example, as shown in FIG. 14 in one embodiment the body 22 includes three sides wherein two of the three sides include a protrusion 28 extending therefrom. The protrusions 28 may each have any suitable size and/or shape, including different sizes and shapes from other protrusions, without departing from the scope of the present invention. For example, as shown in FIG. 15 in one embodiment the body 22 includes a plurality of protrusions 28 including three different shaped protrusions, and FIG. 16 illustrates an embodiment wherein the body 22 includes three different sized protrusions. As an additional example, in one embodiment the protrusions 28 each extend outward from the body 22 between about 0.05 inches and about 0.07 inches (e.g., measured as the length 68 shown in FIG. 11). The specific shape and/or size of each protrusion 28 may, in one embodiment, be selected to facilitate reception between a predetermined sized and/or shaped covering and/or to facilitate relief of discomfort. Of course, if any or generally all of the apparatus 20 is as shown in FIGS. 14-16, the appearance of the apparatus 20 may appear different than as shown in FIGS. 1-4, 11, 12, 13, and 18.

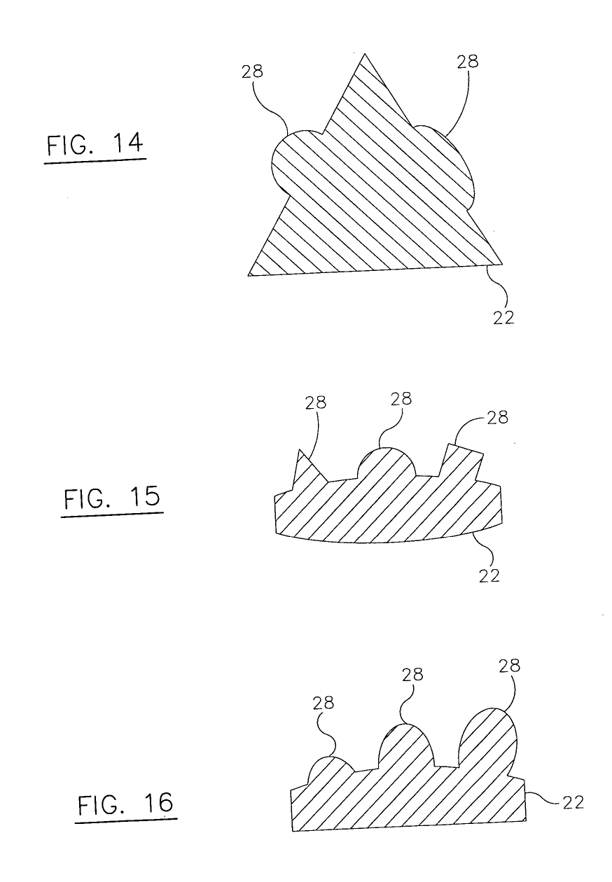

As discussed above, FIGS. 1-4, 11, 12, 13, and 18 illustrate an embodiment wherein the protrusions each extend outward from the curved side 48. Specifically, as may be best illustrated in FIGS. 11 and 13 the protrusions 28 each extend outward from the body 22 to an outer edge 70, wherein a front side 72 of each protrusion extends from the body to the outer edge 70 and a back side 74 of each protrusion extends to the outer edge. As discussed above, although the protrusions 28 as shown in FIGS. 11 and 13 may extend outward from the body 22 at any suitable length, in one embodiment the protrusions each extend a length 68 of between about 0.05 inches and about 0.07 inches as measured between the body and the outer edge 70. Although both the front side 72 and the back side 74 are shown in FIGS. 11 and 13 as generally oblique to the longitudinal axis 36, the front side and/or the back side may be aligned generally perpendicular (e.g., FIG. 17) to the longitudinal axis without departing from the scope of the present invention. Additionally, although both the front side 72 and the back side 74 of the embodiment of FIGS. 1-4, 11, 12, 13, and 18 are generally curved (as is best shown in FIG. 11), the front side and/or the back side may be generally planar without departing from the scope of the present invention.

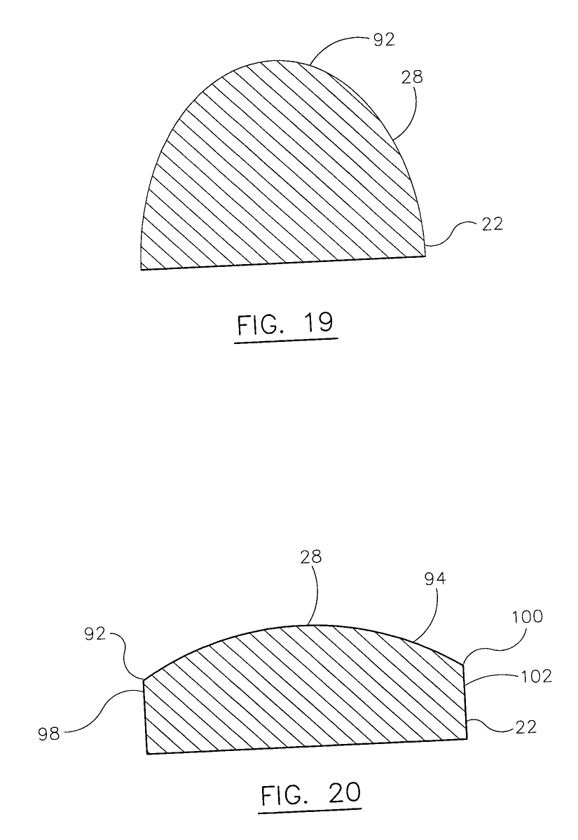

Although the protrusions 28 may be arranged in any suitable configuration (e.g., side by side or staggered) without departing from the scope of the present invention, in the embodiment illustrated in FIGS. 1-4, 11, 12, 13, and 18, the protrusions 28 are arranged sequentially along the longitudinal axis 36 of the body 22. Furthermore, in the embodiment shown in FIGS. 1-4, 11, 12, 13, and 18, the protrusions 28 each extend outward from the body 22 along a length 76 substantially equal to a width 78 of the body, as is best shown in FIGS. 2 and 18. The width 78 of the body 22 is measured in the embodiment of FIG. 18 as a length of the linear side 42. However, any of the protrusions 28 may extend along a length greater than or less than (e.g., FIGS. 14-16) a width of the body and/or a length of a generally linear side of the body without departing from the scope of the present invention.

Although a cross section of the body 22 and a protrusion 28 (a cross section extending through the a portion of the body and a portion of a protrusion) may include any shape without departing from the scope of the present invention, in the embodiment of FIGS. 1-4, 11, 12, 13, and 18 a cross section of the body and a protrusion, as illustrated in FIG. 18, the generally linear side 42 and a generally curved side 90. Although the cross section of FIG. 18 may be taken through any portion of the protrusion 28 without departing from the scope of the present invention, in the embodiment of FIG. 13 the cross section is taken through the protrusion such that the curved side 90 is also the outer edge 70 of the protrusion, as can be seen from FIG. 3. As shown in FIG. 13, the curved side 90 has a generally constant radius and extends from the first end 50 of the generally linear side 42 to the second end 52 of the generally linear side, such that the cross section of FIG. 13 is generally semicircular. However, in other embodiments the cross sectional shapes of the body 22 and a protrusion 28 described and/or illustrated herein may include a curved side with a variable radius without departing from the scope of the present invention (e.g., the curved side 92 of FIG. 23). Additionally, in other embodiments the cross sectional shapes of the body 22 and a protrusion 28 described and/or illustrated herein may include a curved side that does not extend all way from one end of a linear side to another end of the same linear side. For example, FIG. 24 illustrates a curved side 94 that extends from an end 96 of a linear side 98 to an end 100 of another linear side 102. Although the cross section of the body 22 and a protrusion 28 shown in FIG. 13 includes only two sides, a cross section of the body 22 and a protrusion 28 may have any number of sides without departing from the scope of the present invention.

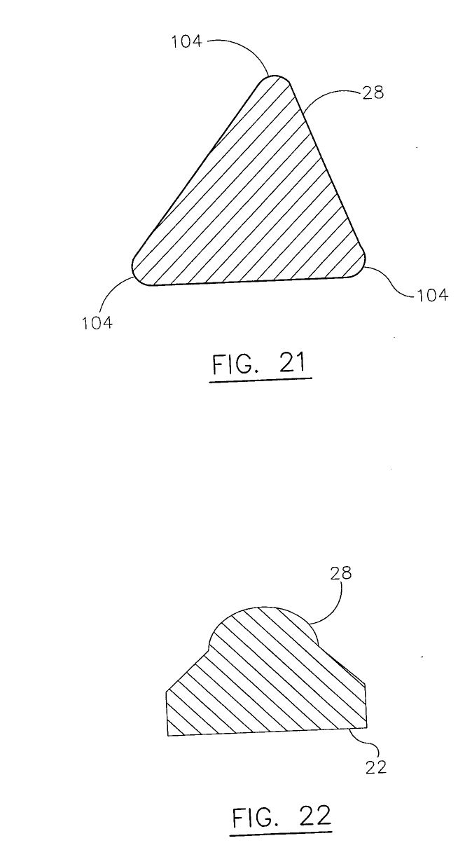

Other cross sectional shapes for all or a portion(s) of the body 22 and a protrusion 28 (in place of and/or in addition to other cross-sectional shapes described and/or illustrated herein) besides a two-sided cross-sectional shape as shown in FIGS. 18 and 19, include, but are not limited to, generally triangular (e.g., the cross section of FIG. 21 including rounded edges 104), generally quadrilateral (e.g., the cross section of FIG. 20), and/or comprised of at least five sides (e.g., the cross section of FIG. 22).

Of course, if all or a portion(s) of the body 22 and a protrusion 28 includes a cross-sectional shape as shown in FIGS. 19-22, the appearance of the apparatus 20, and specifically the body 22, may appear different than as shown in FIGS. 1-4, 11, 12, 13, and 18.

As can be seen from FIG. 2, the cross section of FIG. 18 (and/or in one embodiment the cross sections of FIGS. 19-22) is taken along a line generally perpendicular to the longitudinal axis 36 of the body 22. However, in other embodiments the cross sectional shapes of the body 22 and a protrusion 28 described and/or illustrated herein may be taken along lines generally not perpendicular to the longitudinal axis 36 of the body without departing from the scope of the present invention.

As can be seen from various exemplary cross sections of the body 22 and the protrusion 28 and the body described and/or illustrated herein, a protrusion 28 (taken alone) may have any general cross-sectional shape without departing from the scope of the present invention, no matter what portion of the protrusion the cross section extends through and no matter what angle the cross section is taken with respect to the protrusion, the body, an axis of either, etc. Such cross-sectional shapes are not limited to any of the examples described and/or illustrated herein.

The body 22 and protrusions 28 may be formed from any suitable material or combination of materials without departing from the scope of the present invention. In one embodiment, the body 22 and/or at least one of the protrusions 28 include a material that is generally non-allergenic to skin, such as high density polyethylene. In one embodiment, the body 22 and/or at least one of the protrusions 28 are formed from and/or include a material that is sterilizable to facilitate preventing infection or injury to the person wearing the cast 24. The body 22 and/or at least one of the protrusions 28 may, in one embodiment, be formed from and/or include a flexible material to facilitate inserting a portion of the body 22 between the cast 24 and the skin 26. In one embodiment, the body 22 has sufficient stiffness to be pushed downwardly between the cast 24 and the skin 26 without curling up but is sufficiently flexible to bend for turning corners and/or avoiding wounds covered by the cast. Although other materials may be used without departing from the scope of the present invention, in one embodiment at least one of the body and the protrusions include polypropylene copolymer.

Although the protrusions 28 and the body 22 may be formed from and/or include materials different from one another without departing from the scope of the present invention, in one embodiment the body 22 and at least one of the protrusions are formed from and/or include the same material(s). Additionally, each protrusion 28 may be formed from and/or include the same and/or different materials from other protrusions without departing from the scope of the present invention. Furthermore, the body 22 and the protrusions 28 may be integrally and/or separately formed without departing from the scope of the present invention.

Referring now to FIG. 1, and as discussed above, as the body 22 is moved along the outer surface 30 of the skin 26, the protrusion(s) 28 scratch the outer surface to relieve discomfort such as itchiness and/or other uncomfortable sensations. The shape of the body 22 and the protrusions 28, as well as the arrangement of protrusions on the body, described and/or illustrated herein facilitates relieving such discomfort without causing damage to the cast 24 and/or injury to the person wearing the cast. For example, the shape of the protrusions 28 of the embodiment of FIGS. 1-4, 11, 12, 13, and 18 is intended to provide relief without causing injury to the person wearing the cast. Because the linear side 42 is generally flat, it further facilitates preventing damage to the cast 24 (or portions thereof such as a gauze lining) when the protrusions 28 are moved along the skin 26 and the linear side is thus facing the cast. Additionally, any portion of the body 22 and/or a protrusion 28 may include a rounded edge to facilitate preventing unintended damage to the cast and/or injury to the person wearing the cast. The linear side 42 may also facilitate positioning of the body 22 between the cast 24 and the skin 26 at a location providing relief, as well as general movement of the body to scratch the outer surface 30 of the skin. Furthermore, gaps between each protrusion 28 may facilitate collecting and removing debris, such as dead skin and pieces broken from the cast, that may also cause discomfort. The apparatus 20 may also allow a person to relieve discomfort using the apparatus where/when it would otherwise be inconvenient or inappropriate to do so, for example without manipulating and/or removing the cast 24 or other covering.

Throughout portions of the Detailed Description of the Preferred Embodiment and FIGS. 1-22, apparatus of the present invention for scratching beneath a covering is described and illustrated with respect to a cast 24 covering a portion of a person's leg. However, practice of the present invention is not limited to use with a cast, nor to a person's leg. Rather, as used herein a “covering” is may be any thing covering all or a portion of a living organism's body. For example, a “covering” as used herein may be, but is not limited to, a cast, a splint, a bandage, an item of clothing (including hats and shoes) or ornamentation, and/or a portion of the living organism's (or another's) body (e.g., hair), etc.

As used herein, “side” may refer to a one and/or two dimensional line such as a line forming a portion of a cross section and/or a two and/or three-dimensional surface.

Exemplary embodiments of apparatus are described above in detail. The apparatus are not limited to the specific embodiments described herein, but rather, components of each apparatus may be utilized independently and separately from other components described herein. Each apparatus component can also be used in combination with other apparatus components.

When introducing elements of the present invention or the preferred embodiment(s) thereof, the articles “a”, “an”, “the” and “said” are intended to mean that there are one or more of the elements. The term “plurality” is intended to mean there are two or more of the corresponding elements. The term “multiplicity” is intended to mean that there are three or more of the corresponding elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. Apparatus for scratching beneath a covering, said apparatus comprising:
an elongate body sized to be at least partially received between the covering and skin covered by the covering;
a protrusion extending outward from the body for scratching an outer surface of the covered skin; and
a cross section of the body being generally non-quadrilateral with at least one generally linear side, wherein the cross section does not extend through the protrusion.

2. Apparatus in accordance with claim 1 wherein said cross section of the body comprises the generally linear side and a generally curved side.

3. Apparatus in accordance with claim 2 wherein the generally curved side has a variable radius.

4. Apparatus in accordance with claim 2 wherein the generally curved side extends from a first end of the generally linear side to a second end of the generally linear side opposite the first end.

5. Apparatus in accordance with claim 4 wherein the cross section is semicircular.

6. Apparatus in accordance with claim 2 wherein the protrusion extends outward from the curved side.

7. Apparatus in accordance with claim 1 wherein at least one of the body and the protrusion comprises a round edge.

8. Apparatus in accordance with claim 1 wherein the body comprises a first end, a second end opposite the first end, and a handle adjacent one of the first and second ends.

9. Apparatus in accordance with claim 8 wherein the handle comprises a central stem extending outward from the body and an extension extending outwardly from the stem.

10. Apparatus in accordance with claim 9 wherein the extension is curved.

11. Apparatus in accordance with claim 1 wherein at least one of the body and the protrusion comprise a generally flexible material.

12. Apparatus in accordance with claim 1 wherein at least one of the body and the protrusion comprise polypropylene copolymer.

13. Apparatus in accordance with claim 1 wherein the protrusion extends between about 0.05 inches and about 0.07 inches outward from the body.

14. Apparatus for scratching beneath a covering, said apparatus comprising:
an elongate body sized to be at least partially received between the covering and skin covered by the covering, said body having a longitudinal axis extending through a length thereof, a cross section of said body being generally symmetrical about a first axis extending through the body and being generally non-symmetrical about a second axis extending through the body, wherein the first axis is generally perpendicular to the second axis and both the first and second axes are generally perpendicular to the longitudinal axis of the body, and wherein the cross section is taken along a line generally perpendicular to the longitudinal axis of the body;
a protrusion extending outward from the body for scratching an outer surface of the skin covered by the covering; and
wherein the cross section of the body does not extend through the protrusion.

15. Apparatus in accordance with claim 14 wherein the cross section of the body is at least one of generally triangular, and comprised of at least five sides.

16. Apparatus in accordance with claim 14 wherein the body comprises three sides, a plurality of protrusions extend outward from the body, and at least two sides of the three sides of the body comprise a protrusion of the plurality of protrusions extending outward therefrom.

17. Apparatus in accordance with claim 14 wherein the protrusion comprises a curved surface.

18. Apparatus in accordance with claim 14 wherein the cross section is a first cross section, a second cross section of the protrusion having at least two sides.

19. Apparatus in accordance with claim 18 wherein the second cross section comprises a generally curved side.

20. Apparatus in accordance with claim 19 wherein the second cross section is semicircular.

21. Apparatus in accordance with claim 14 wherein a plurality of protrusions extend outward from the body, the plurality of protrusions comprising at least one of at least three different shapes and three different sizes of protrusions.

22. Apparatus in accordance with claim 14 wherein the cross section of the body is generally quadrilateral.

23. Apparatus in accordance with claim 22 wherein the cross section of the body comprises a generally curved side.

24. Apparatus for scratching beneath a covering, said apparatus comprising:
an elongate body sized to be at least partially received between the covering and skin covered by the covering; and
a protrusion extending outward from the body for scratching an outer surface of the covered skin, wherein the protrusion extends outward from the body along a length one of substantially equal to and greater than a width of the body.

25. Apparatus for scratching beneath a covering, said apparatus comprising:
an elongate body sized to be at least partially received between the covering and skin covered by the covering, said body having a generally planar side;
a protrusion extending outward from the body for scratching an outer surface of the covered skin;
a cross section of the body and the protrusion comprising a generally linear side; and
wherein the protrusion extends outward from the body along a length one of substantially equal to and greater than a length of the linear side.

26. Apparatus in accordance with claim 25 wherein the cross section of the body and the protrusion is generally semicircular.

27. Apparatus for scratching beneath a covering, said apparatus comprising:
an elongate body sized to be at least partially received between the covering and skin covered by the covering; and
a protrusion extending outward from the body for scratching an outer surface of the covered skin, wherein the protrusion includes a front side extending from the body to an outer edge of the protrusion and a back side extending from the body to the outer edge.

28. Apparatus in accordance with claim 27 wherein at least one of the front side and the back side is curved.

29. Apparatus in accordance with claim 27 wherein at least one of the front side and the back side is oblique to a longitudinal axis extending through a length of the body.

30. Apparatus for scratching beneath a covering, said apparatus comprising:
an elongate body sized to be at least partially received between the covering and skin covered by the covering;
a protrusion extending outward from the body for scratching an outer surface of the covered skin; and
a cross section of the body and the protrusion being at least one of generally triangular, generally quadrilateral, and comprised of no more than five sides.

31. Apparatus in accordance with claim 30 wherein the cross section comprises a generally curved side.

32. Apparatus for scratching beneath a covering, said apparatus comprising:
an elongate body sized to be at least partially received between the covering and skin covered by the covering;
a protrusion extending outward from the body for scratching an outer surface of the covered skin; and
a cross section of the body and the protrusion comprising a generally linear side and a generally curved side, wherein the generally curved side extends from a first end of the generally linear side to a second end of the generally linear side opposite the first end.

33. Apparatus in accordance with claim 32 wherein the cross section of the body and the protrusion is generally semicircular.

34. Apparatus in accordance with claim 32 wherein the generally curved side has a variable radius.

35. Apparatus for scratching beneath a covering, said apparatus comprising:
an elongate body sized to be at least partially received between the covering and skin covered by the covering;
a plurality of protrusion extending outward from the body for scratching an outer surface of the covered skin, wherein the plurality of protrusions are arranged sequentially along a longitudinal axis extending through a length of the body.

36. Apparatus in accordance with claim 35 wherein a protrusion of the plurality of protrusion comprises a generally curved side.
